(19) United States
(12) Patent Application Publication
(10) Pub. No.: US 2025/0086621 A1
(43) Pub. Date: Mar. 13, 2025

(54) METHODS AND SYSTEMS FOR FACILITATING SECURE PAYMENT FOR A TRANSACTION

(71) Applicant: Emporium Investments, Chicago, IL (US)

(72) Inventor: Iyobosa Ero, Chicago, IL (US)

(21) Appl. No.: 18/505,886

(22) Filed: Nov. 9, 2023

Related U.S. Application Data
(60) Provisional application No. 63/581,220, filed on Sep. 7, 2023.

(51) Int. Cl. G06Q 20/38; G06Q 20/32

(52) U.S. Cl. CPC G06Q 20/385; G06Q 20/3255

(57) ABSTRACT

The present disclosure provides a method for facilitating secure payment for a transaction. Additionally, the method may include receiving a short message service (SMS)—based payment indication corresponding to a transaction, receiving merchant data associated with the transaction, generating a unique payment request code associated with the transaction, transmitting the unique payment request code to the network connected device, receiving a short message service (SMS) message from the network connected device, verifying a user identity of the user based on the SMS message, analyzing the unique payment request code, initiating a transfer of a payment from a user financial account to the merchant financial account based on the verifying of the user identity and the analyzing of the unique payment request code, and transmitting an acknowledgment short message service (SMS) message to the network connected device based on the initiating.

### FIELD OF DISCLOSURE

The present disclosure generally relates to authorization, e.g. identification of payer or payee and verification of customer or shop credentials. More specifically, the present disclosure relates to methods and systems for facilitating secure payment for a transaction.

### BACKGROUND

In the modern digital era, payment systems have evolved significantly to meet the growing demands of consumers and merchants. Traditional payment methods, such as credit cards and cash transactions, have limitations in terms of security, accessibility, and convenience. Contactless payment systems and mobile wallets have addressed some of these concerns but often require dedicated hardware or specific applications.

Online shopping and retail checkout processes also face challenges in ensuring smooth and efficient transactions. Cart abandonment rates can be relatively high, often attributed to complex checkout procedures and concerns about the security of payment information.

Existing payment systems have several shortcomings that hinder a seamless and user-friendly experience for consumers and merchants. For instance, existing payment systems are hardware-dependent. The hardware-dependent payment systems require specialized hardware or devices for transaction processing, limiting their accessibility and adoption. Moreover, existing payment systems have complex checkout procedures. The complex checkout procedures involve multiple steps and data entry, which leads to higher cart abandonment rates and a loss of potential revenue for merchants. Furthermore, the existing payment systems are prone to security threats, which makes consumers and merchants cautious about sharing sensitive payment information through various payment gateways. Further, existing payment systems have limited compatibility, which means these systems may not be universally accepted across different industries or retail platforms, leading to inconvenience for consumers and merchants.

The field relating to authorization, e.g. identification of payer or payee, verification of customer or shop credentials is technologically important to several industries, business organizations, and/or individuals. Existing techniques for facilitating secure payment for a transaction are also deficient in several ways. For instance, current technologies do not include the usage of a message service for facilitating secure payment for a transaction. As a result, different technologies are needed that use the message service to facilitate secure payment for the transaction. Moreover, current technologies require physical cards, contactless devices, or complicated payment gateways to facilitate secure payment for a transaction. As a result, different technologies are needed that offer a fast and efficient alternative for making payments without requiring physical cards, contactless devices, or complicated payment gateways. Furthermore, current technologies are prone to issues like network failure, invalid input, or API errors while processing a payment. As a result, different technologies are needed that have the ability of error handling to deal with issues like network failure, invalid input, or API errors while processing the payment.

Therefore, there is a need for methods and systems for facilitating secure payment for a transaction that may overcome one or more of the above-mentioned problems and/or limitations.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method for facilitating secure payment for a transaction. Also, the method may include receiving, using a communication device, a short message service (SMS)-based payment indication corresponding to a transaction. Moreover, the SMS-based payment indication may be received from a network connected device associated with at least one of a user and a merchant. Moreover, the transaction may be associated with each of the user and the merchant. Further, the method may include receiving, using the communication device, merchant data associated with the transaction. Further, the merchant data may include at least one account data associated with a merchant financial account. Additionally, the method may include generating, using a processing device, a unique payment request code associated with the transaction. Also, the method may include transmitting, using the communication device, the unique payment request code to the network connected device. Further, the method may include receiving, using the communication device, a short message service (SMS) message from the network connected device. Moreover, the SMS message includes the unique payment request code. Moreover, the SMS message may be received over a cellular network. Additionally, the method may include verifying, using the processing device, a user identity of the user based on the SMS message. Also, the method may include analyzing, using the processing device, the unique payment request code. Further, the method may include initiating, using the processing device, a transfer of a payment from a user financial account to the merchant financial account based on the verifying of the user identity and the analyzing of the unique payment request code. Additionally, the method may include transmitting, using the communication device, an acknowledgment short message service (SMS) message to the network connected device. Moreover, the transmitting may be based on the initiating.

The present disclosure provides a system for facilitating secure payment for a transaction. Further, the system may include a communication device. Additionally, the communication device may be configured for receiving a short message service (SMS)-based payment indication corresponding to a transaction. Also, the SMS-based payment indication may be received from a network connected device associated with at least one of a user and a merchant. Also, the transaction may be associated with each of the user and the merchant. Also, the communication device may be configured for receiving merchant data associated with the transaction. Further, the merchant data may include at least one account data associated with a merchant financial account. Further, the communication device may be configured for transmitting a unique payment request code to the network connected device. Additionally, the communication device may be configured for receiving a short message service (SMS) message from the network connected device. Also, the SMS message includes the unique payment request code. Also, the SMS message may be received over a cellular network. Also, the communication device may be configured for transmitting an acknowledgment short message service (SMS) message to the network connected device. Accordingly, the system may include a processing device communicatively coupled with the communication device. Furthermore, the processing device may be configured for generating the unique payment request code associated with the transaction. Also, the processing device may be configured for verifying a user identity of the user based on the SMS message. Further, the processing device may be configured for analyzing the unique payment request code. Moreover, the processing device may be configured for initiating a transfer of a payment from a user financial account to the merchant financial account based on the verifying of the user identity and the analyzing of the unique payment request code. Further, the transmitting of the acknowledgment SMS message to the network connected device may be based on the initiating.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3A illustrates a flowchart of a method 300 for facilitating secure payment for a transaction, in accordance with some embodiments.

FIG. 3B illustrates a continuation of the flowchart of the method 300 for facilitating secure payment for a transaction, in accordance with some embodiments.

FIG. 4 illustrates a flowchart of a method 400 for facilitating secure payment for a transaction including performing, using the processing device, a remedial action, in accordance with some embodiments.

FIG. 5 illustrates a flowchart of a method 500 for facilitating secure payment for a transaction including reconciling, using the processing device, a transaction record, in accordance with some embodiments.

FIG. 6 illustrates a flowchart of a method 600 for facilitating secure payment for a transaction including generating, using the processing device, a transaction report, in accordance with some embodiments.

FIG. 7 illustrates a flowchart of a method 700 for facilitating secure payment for a transaction including performing, using the processing device, a remedial action based upon determining, in accordance with some embodiments.

FIG. 8 illustrates a block diagram of a system 800 for facilitating secure payment for a transaction, in accordance with some embodiments.

FIG. 9 illustrates a block diagram of the system 800 for facilitating secure payment for a transaction, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview:

The present disclosure describes systems and methods for facilitating secure payment for a transaction.

Further, the present disclosure may relate to the technical field of payment systems and electronic transaction processing. The methods and systems disclosed herein operate at the intersection of mobile communication technologies and financial services, offering an innovative approach to facilitating secure payments.

Further, the methods and systems disclosed herein address the need for a user-friendly, convenient, and versatile payment infrastructure that can be utilized in a wide range of industries, including online retail, restaurants, supermarkets, and grocery stores. By integrating SMS/text messaging technology into the payment process, the methods and systems described herein eliminate the need for physical cards, contactless devices, or complicated payment gateways, offering consumers a fast and efficient alternative for making payments while providing merchants with a cost-effective and streamlined transaction solution.

Further, the present disclosure describes an SMS-based payment system for online and retail checkout processes. Further, the SMS-based payment system may leverage the ubiquity and simplicity of text messaging and maintain robust security measures. Further, the SMS-based payment system enables seamless and secure transactions during online and in-person checkout processes.

In some embodiments, the SMS-based payment system described herein provides a comprehensive solution for streamlined and secure transactions during online and in-person checkout processes. The SMS-based payment system provides a feature of user registration and verification through which consumers must initially register their mobile phone numbers with the SMS-based payment system and undergo a one-time verification process to ensure authenticity and security. Further, the SMS-based payment system also provides merchant integration for participating merchants by providing an SMS-based payment option that may be integrated into their checkout systems. The merchant integration may be accomplished through API integration, which allows seamless payment processing. During a checkout process, a consumer may be presented with an option to make a payment via SMS to a merchant. Upon selecting the option, the SMS-based payment system may generate a unique payment request code linked to a specific transaction. The consumer may initiate the payment by sending an SMS containing the unique payment request code to a designated system number. The SMS-based payment system may verify the unique payment request code and an identity of the consumer before proceeding. Once the payment is authorized, both the consumer and the merchant receive an SMS confirmation of the specific transaction being successful. A digital receipt of the payment may generated and kept for record-keeping.

Further, the SMS-based payment system includes an ability of error handling to deal with potential issues like network failures, invalid inputs, or API errors. Proper error handling may ensure that the SMS-based payment system remains reliable and user-friendly. While the SMS-based payment system addresses security concerns through the unique payment request code, additional security measures, such as encryption, secure communication protocols, and a two-factor authentication may be used to protect sensitive data during the transaction to prevent unauthorized access. The SMS-based payment system may include mechanisms for verifying an accuracy of payments and reconciling transaction records to ensure financial integrity to avoid discrepancies. The SMS-based payment system may also allow the consumer to view payment history and manage payment accounts, such as adding multiple payment methods, updating phone numbers, and/or setting spending limits and any combination thereof. The SMS-based payment system may provide the merchant with a dashboard and/or a reporting system to track transaction data, monitor sales performance, and/or gain valuable insights into consumer behaviors. The SMS-based payment system may comply with relevant financial regulations and/or data protection laws to safeguard the consumer's and the merchant's interests. The SMS-based payment system may be scalable to handle an increasing number of transactions and user registrations over time. The SMS-based payment system may be deployed on a cloud platform. The SMS-based payment system provides an intuitive and user-friendly interface for both consumers and merchants. The intuitive and user-friendly interface provides a smooth and enjoyable user experience, which encourages adoption and retention of the SMS-based payment system. The SMS-based payment system may implement fraud detection and prevention mechanisms to identify and block suspicious transactions, which safeguards both the consumer and the merchant from potential losses. Further, the SMS-based payment system may be integrated with a third party such as e-commerce platforms, point-of-sale systems, and/or other payment gateways to enhance compatibility and adoption of the SMS-based payment system. The SMS-based payment system also provides robust customer support channels to assist the consumer and the merchant with an inquiry or an issue related to the SMS-based payment system. The SMS-based payment system also continuously gathers feedback from users (such as consumers and merchants) and other stakeholders, to improve the SMS-based payment system's features, performance, and security. Further, the SMS-based payment system addresses real-world challenges associated with payment processing and provides a seamless experience for the consumer and the merchant alike.

Further, the SMS-based payment system may be associated with a flow. Further, the flow describes sequences of activities within the SMS-based payment system. Further, each of the activities represents a specific action and/or an operation within the SMS-based payment system. The flow may begin with a “Start Registration Activity”, where the consumer initiates a registration process for registering the consumer. The SMS-based payment system may then validate a phone number associated with the consumer and may generate a unique token which may be stored by the SMS-based payment system in a database for future verification. After registering the consumer, a “Payment Request Generation Activity” may be triggered during a checkout process. The SMS-based payment system may then generate a unique payment request code linked to a specific transaction. Next, a “Payment Authorization Activity” may be executed, where the consumer may send the unique payment request code via SMS to authorize a payment. The SMS-based payment system may call a merchant's API to verify the payment and receive an authorization result. Depending on the authorization result, a flow may branch into two paths: one for a successful payment authorization and another for a failed authorization. In either case, the SMS-based payment system may send an SMS confirmation to the consumer about a status of the transaction. Finally, the flow may end with an “End Transaction Activity”, signifying a completion of the payment.

Further, the Pseudo-Code for SMS-Based Payment System may be as follows:

```
  // Data Structures
  DEFINE Dictionary merchantData // Stores merchant information (e.g., merchant ID,
API endpoint)
  DEFINE Dictionary consumerData // Stores consumer information (e.g., phone
number, payment tokens)
  // Function to Register Consumer
  FUNCTION registerConsumer(consumerPhoneNumber):
    IF consumerPhoneNumber is not in consumerData:
      GENERATE uniqueToken
      consumerData[consumerPhoneNumber] = uniqueToken
    END IF
  END FUNCTION
  // Function to Generate Payment Request Code
  FUNCTION generatePaymentRequestCode(consumerPhoneNumber, transactionID):
    IF consumerPhoneNumber is in consumerData:
      GENERATE uniquePaymentRequestCode
      STORE uniquePaymentRequestCode in a temporary data store (e.g., database)
      RETURN uniquePaymentRequestCode
    END IF
    RETURN NULL
  END FUNCTION
  // Function to Authorize Payment
  FUNCTION authorizePayment(consumerPhoneNumber, paymentRequestCode):
    IF consumerPhoneNumber is in consumerData AND paymentRequestCode exists
in temporary data store:
      REMOVE paymentRequestCode from temporary data store
      // Perform payment authorization steps here (e.g., verify payment, charge
consumer, notify merchant)
      RETURN true
    END IF
    RETURN false
  END FUNCTION
  // Function to Integrate Payment Option into Merchant Checkout
  FUNCTION integratePaymentOption(merchantID, apiEndpoint):
    IF merchantID is not in merchantData:
      merchantData[merchantID] = apiEndpoint
    END IF
  END FUNCTION
  // Function to Send SMS Confirmation
  FUNCTION sendSMSConfirmation(phoneNumber, message):
    // Code to send an SMS to phoneNumber containing message
  END FUNCTION
  // Main Program (Example Flow during Checkout Process)
  FUNCTION main(consumerPhoneNumber, transactionID, merchantID):
    registerConsumer(consumerPhoneNumber)
    paymentRequestCode = generatePaymentRequestCode(consumerPhoneNumber,
transactionID)
    IF paymentRequestCode is not NULL:
      apiEndpoint = merchantData[merchantID]
      paymentAuthorizationResult = callApiEndpoint(apiEndpoint,
consumerPhoneNumber, paymentRequestCode)
      IF paymentAuthorizationResult is true:
        sendSMSConfirmation(consumerPhoneNumber, “Payment successful for
Transaction ID: ” + transactionID)
        sendSMSConfirmation(merchantID, “Payment received for Transaction ID: ”
+ transactionID)
      ELSE:
        sendSMSConfirmation(consumerPhoneNumber, “Payment authorization
failed for Transaction ID: ” + transactionID)
      END IF
    END IF
  END FUNCTION
```

Further, the SMS-based payment system may include a pre-authorization function. Further, the pre-authorization function may have many advantages including efficiently providing a subscriber (such as a consumer) with a record or a textual summary of each transaction for reviewing details regarding each transaction's payment authorization. The subscriber may be able to check the record daily, or at any time, the subscriber may wish, by accessing a text-messaging box that stores the record in a mobile phone. An SMS message may be generated and sent after each transaction's payment authorization, thereby efficiently and frequently updating the subscriber of a pre-authorization transaction. A record of the SMS message may include details of authorized payment transactions since the last time the subscriber checked or accessed the record. On each occasion a PCA system may be contacted for validation of a payment card's user and authorization of a payment card's transaction, the PCA system may require a text alert or a notification stating that a central database aligns the subscriber details recorded therein in a Validation Record with retail payment transaction's details. The PCA system then formulates the subscriber and a retailer (such as a merchant) details into the SMS message. The SMS message may be sent by the PCA system to the subscriber either immediately or at a predetermined time after the payment for the transaction. The successful transmission of the SMS message may be confirmed by a return message to the PCA system indicating successful transmission.

Further, the present disclosure describes a method for performing a commercial transaction by a consumer. Further, the consumer has a computer that may be connected to a public network and an SMS terminal and can receive and send SMS messages over a cellular network. The consumer can order the article through the computer that communicates with a commercial server via the public network. The method may include sending an SMS message from the commercial server through the cellular network. Further, the SMS message may include an address on the cellular network of a payment server, which may include information about the article. Further, the consumer, after receiving the SMS message on the SMS terminal, may be redirected to the payment server with a modified SMS message. Further, at least one information enabling an identification of a consumer payment means may be added to the modified SMS message.

Further, the present disclosure describes a system for facilitating a payment via SMS. Further, the system allows a user (such as a consumer or a merchant) to receive an address of a payment server through an SMS and respond back to the payment server through the SMS. Further, the user may not be required to send a credit card number to a commercial site after ordering an article over a public network such as an Internet network.

Further, the system may leverage a current mobile telephone and an SMS architecture as well as current electronic payment methods (e.g. Visa®, MasterCard®, American Express®, Discover®, JCB®, PayPal®, private label accounts, etc.) processing architectures and legacy payment systems to allow secure transactions to be carried out over these legacy systems that have been initiated via an SMS message using a mobile or other SMS-enabled devices. In one embodiment, the consumer, in possession of a PayPal® or other like payment account, while viewing products being sold on a shop-from-home television network, initiates a purchase transaction by sending payment instructions via the SMS to an SMS shortcode (or some other like address, telephone number or some similar destination identifier) appearing on the television screen. Suitably, the system for processing an instruction receives the SMS message and passes appropriate information into the shop-from-home television network's legacy order processing and management system. For example, when the system receives a message initiating a new transaction, a unique transaction ID may be assigned to the new transaction. Further, the unique transaction ID may be stored or recorded in a transaction database. Similarly, a corresponding message sent from the system to the mobile or other SMS-enabled devices may be recorded in the transaction database using the unique transaction ID. Further, the system may be able to recognize a progress of the transaction at a given point in time by linking or chaining messages together. For example, at a particular point during the transaction, based upon one or more messages already recorded in the transaction database under the transaction ID, the system knows to expect authentication credentials or some other allowable form or type of reply or message from the mobile or other SMS-enabled devices.

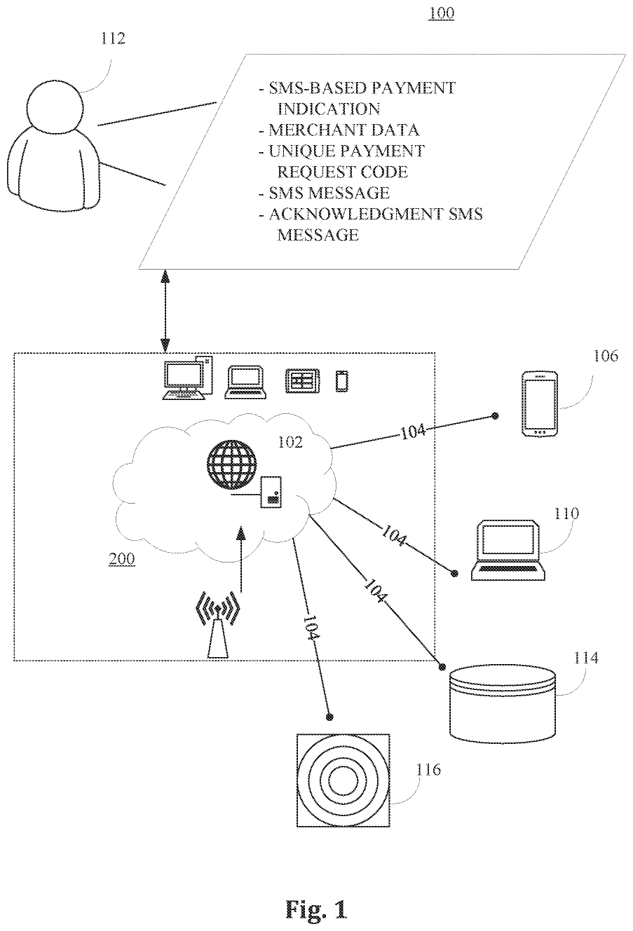

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

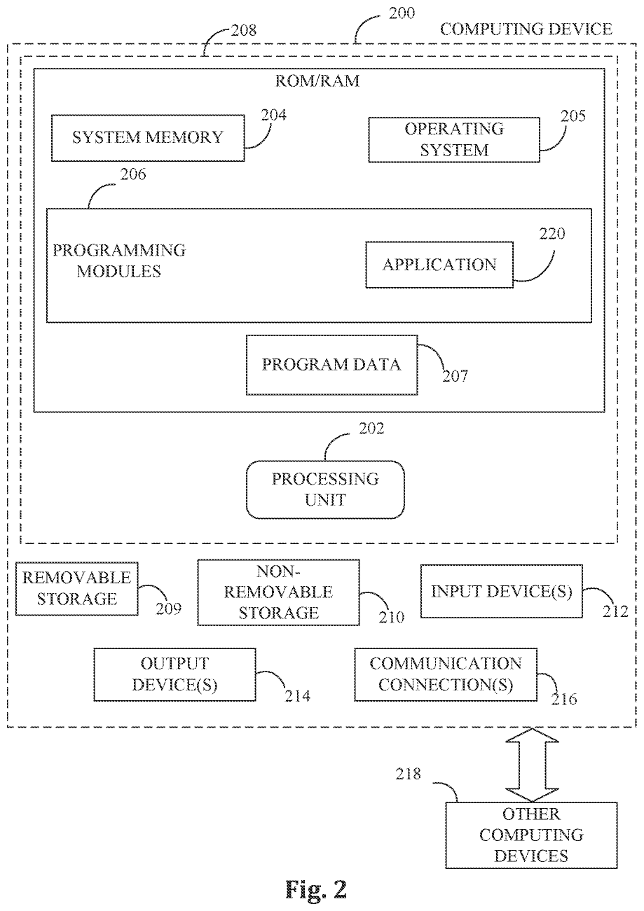

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and a program data 207. Operating system 205, for example, may be suitable for controlling computing device 200's operation. In one embodiment, programming modules 206 may include image-processing modules and machine learning modules. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable, and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD), or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

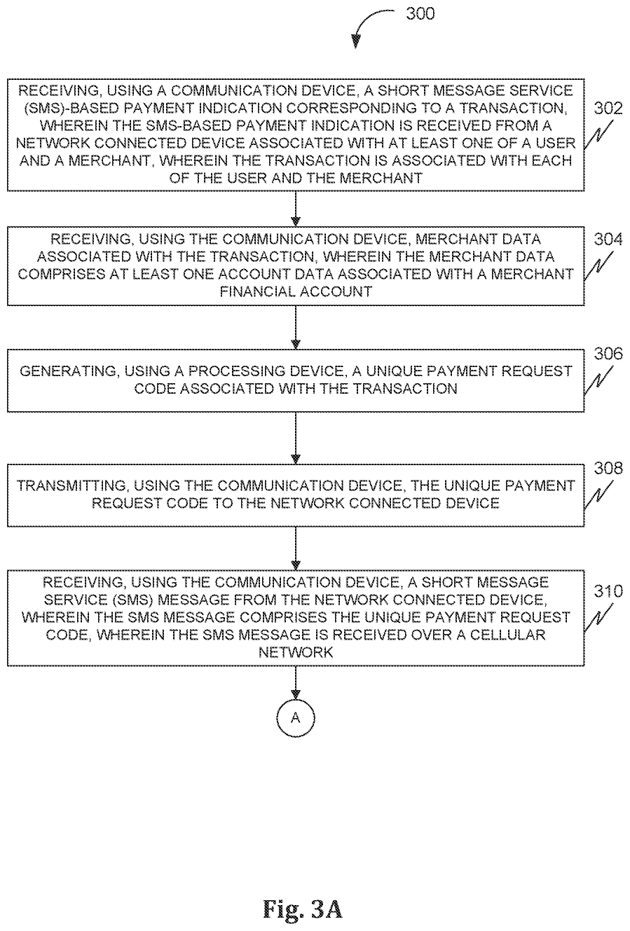

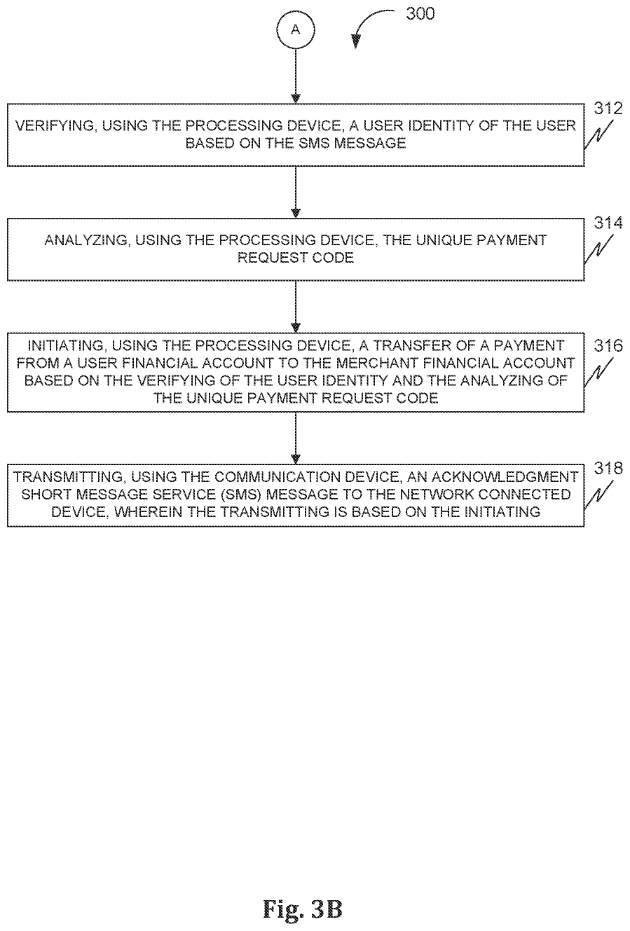

FIG. 3A and FIG. 3B illustrate a flowchart of a method 300 for facilitating secure payment for a transaction, in accordance with some embodiments.

Accordingly, the method 300 may include a step 302 of receiving, using a communication device (such as a communication device 802), a short message service (SMS)-based payment indication corresponding to a transaction. Furthermore, the SMS-based payment indication may be received from a network connected device (such as a network connected device 902) associated with at least one of a user and a merchant. Further, the user may be a consumer. Further, the user and the merchant may be a participant. Further, the network connected device may include a client device, a computer, etc. Furthermore, the transaction may be associated with each of the user and the merchant. Also, the method 300 may include a step 304 of receiving, using the communication device, merchant data associated with the transaction. Further, the merchant data may include at least one account data associated with a merchant financial account. Further, the method 300 may include a step 306 of generating, using a processing device (such as a processing device 804), a unique payment request code associated with the transaction. Additionally, the method 300 may include a step 308 of transmitting, using the communication device, the unique payment request code to the network connected device. Also, the method 300 may include a step 310 of receiving, using the communication device, a short message service (SMS) message from the network connected device. Furthermore, the SMS message includes the unique payment request code. Furthermore, the SMS message may be received over a cellular network. Further, the method 300 may include a step 312 of verifying, using the processing device, a user identity of the user based on the SMS message. Additionally, the method 300 may include a step 314 of analyzing, using the processing device, the unique payment request code. Also, the method 300 may include a step 316 of initiating, using the processing device, a transfer of a payment from a user financial account to the merchant financial account based on the verifying of the user identity and the analyzing of the unique payment request code. Further, the method 300 may include a step 318 of transmitting, using the communication device, an acknowledgement short message service (SMS) message to the network connected device. Furthermore, the transmitting may be based on the initiating.

In some embodiments, the unique payment request code may be generated based on a user cellular network number and a transaction ID associated with the transaction.

In some embodiments, the SMS message may be addressed to a designated cellular phone number.

In some embodiments, the receiving of the SMS-based payment indication may be in accordance with an Application Programming Interface (API).

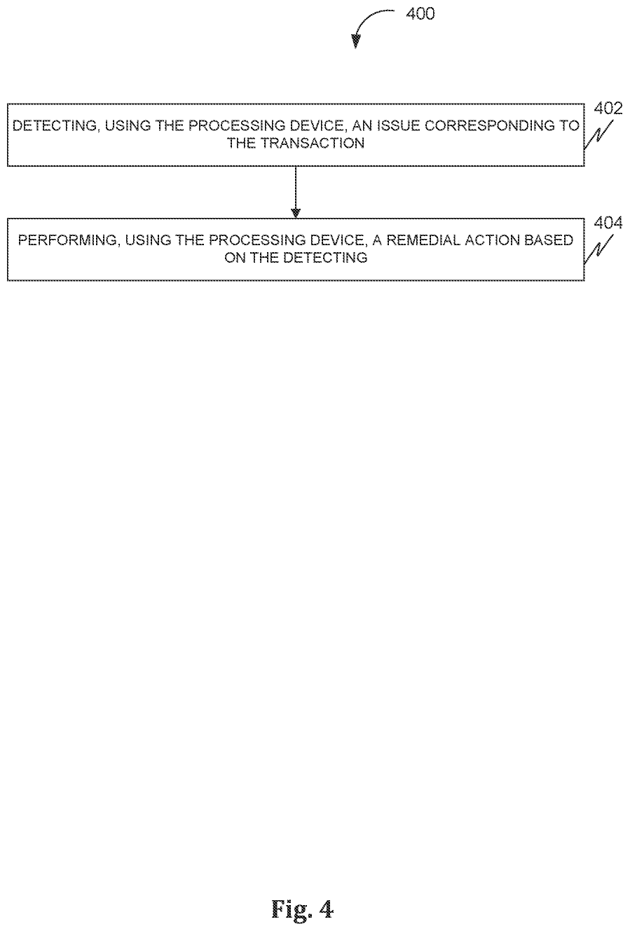

FIG. 4 illustrates a flowchart of a method 400 for facilitating secure payment for a transaction including performing, using the processing device, a remedial action, in accordance with some embodiments.

Additionally, the method 400 further may include a step 402 of detecting, using the processing device, an issue corresponding to the transaction. Also, the method 400 may include a step 404 of performing, using the processing device, a remedial action based on the detecting.

In some embodiments, the issue corresponds to the cellular network. Additionally, the method 400 may include a step of receiving, using the communication device, the SMS message over a non-cellular network based on the performing of the remedial action.

In some embodiments, the method 300 may further include encrypting, using the processing device 804, the unique payment request code to generate an encrypted unique payment request code. Accordingly, the unique payment request code may be transmitted to the network connected device associated with the user. Further, the unique payment request code may be the encrypted unique payment request code.

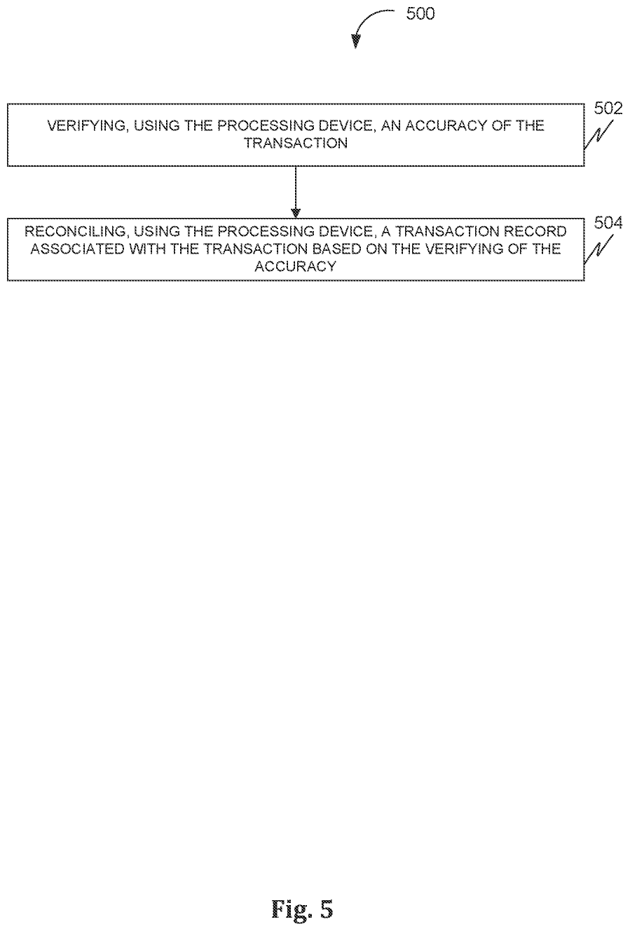

FIG. 5 illustrates a flowchart of a method 500 for facilitating secure payment for a transaction including reconciling, using the processing device, a transaction record, in accordance with some embodiments.

Moreover, the method 500 may include a step 502 of verifying, using the processing device, an accuracy of the transaction. Accordingly, the method 500 further may include a step 504 of reconciling, using the processing device, a transaction record associated with the transaction based on the verifying of the accuracy.

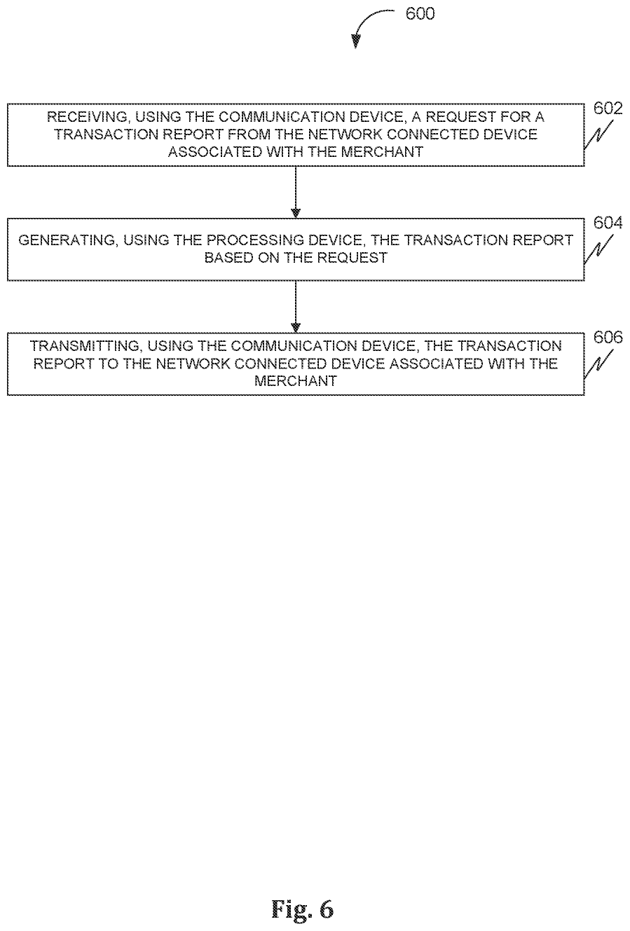

FIG. 6 illustrates a flowchart of a method 600 for facilitating secure payment for a transaction including generating, using the processing device, a transaction report, in accordance with some embodiments.

Also, the method 600 may include a step 602 of receiving, using the communication device, a request for a transaction report from the network connected device associated with the merchant. Further, the method 600 further may include a step 604 of generating, using the processing device, the transaction report based on the request. Additionally, the method 600 further may include a step 606 of transmitting, using the communication device 802, the transaction report to the network connected device associated with the merchant.

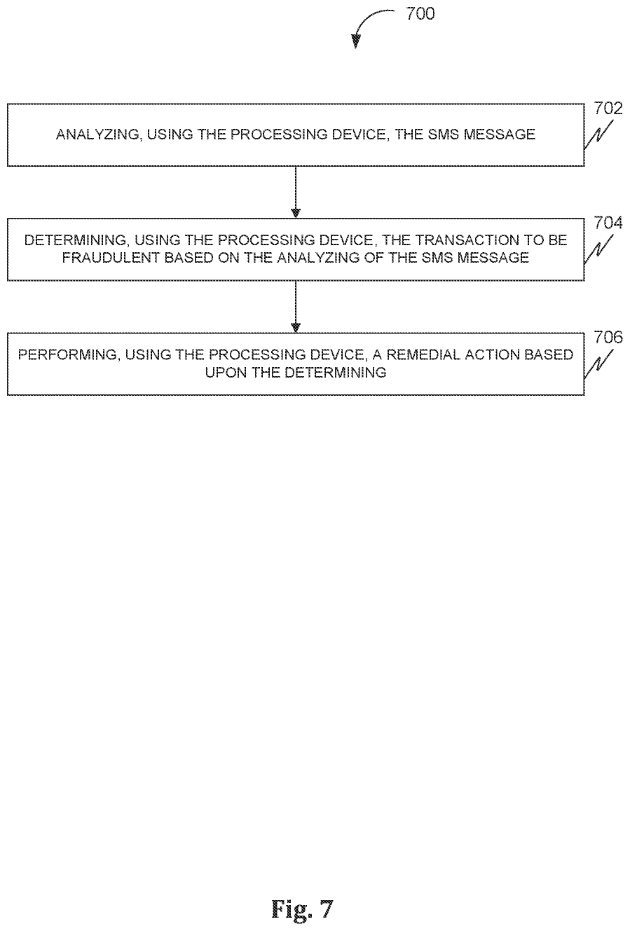

FIG. 7 illustrates a flowchart of a method 700 for facilitating secure payment for a transaction including performing, using the processing device, a remedial action based upon determining, in accordance with some embodiments.

Furthermore, the method 700 may include a step 702 of analyzing, using the processing device, the SMS message. Moreover, the method 700 may include a step 704 of determining, using the processing device, the transaction to be fraudulent based on the analyzing of the SMS message. Accordingly, the method 700 further may include a step 706 of performing, using the processing device, a remedial action based upon the determining.

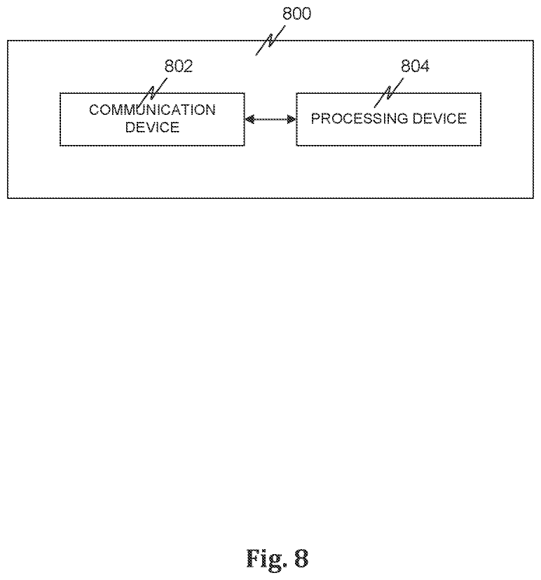

FIG. 8 illustrates a block diagram of a system 800 for facilitating secure payment for a transaction, in accordance with some embodiments. Further, the system 800 may be a SMS-based payment system.

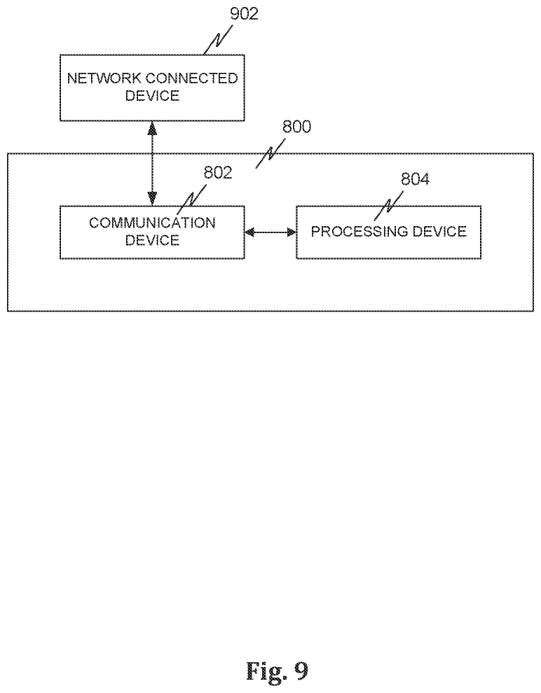

Accordingly, the system 800 may include a communication device 802. Accordingly, the communication device 802 may be configured for receiving a short message service (SMS)-based payment indication corresponding to a transaction. Furthermore, the SMS-based payment indication may be received from a network connected device 902, as shown in FIG. 9, associated with at least one of a user and a merchant. Furthermore, the transaction may be associated with each of the user and the merchant. Furthermore, the communication device 802 may be configured for receiving merchant data associated with the transaction. Further, the merchant data may include at least one account data associated with a merchant financial account. Moreover, the communication device 802 may be configured for transmitting a unique payment request code to the network connected device 902. Accordingly, the communication device 802 may be configured for receiving a short message service (SMS) message from the network connected device 902. Furthermore, the SMS message includes the unique payment request code. Furthermore, the SMS message may be received over a cellular network. Furthermore, the communication device 802 may be configured for transmitting an acknowledgment short message service (SMS) message to the network connected device 902. Additionally, the system 800 may include a processing device 804 communicatively coupled with the communication device 802. Also, the processing device 804 may be configured for generating the unique payment request code associated with the transaction. Further, the processing device 804 may be configured for verifying a user identity of the user based on the SMS message. Furthermore, the processing device 804 may be configured for analyzing the unique payment request code. Further, the processing device 804 may be configured for initiating a transfer of a payment from a user financial account to the merchant financial account based on the verifying of the user identity and the analyzing of the unique payment request code. Further, the transmitting of the acknowledgment SMS message to the network connected device 902 may be based on the initiating.

In some embodiments, the unique payment request code may be generated based on a user cellular network number and a transaction ID associated with the transaction.

In some embodiments, the SMS message may be addressed to a designated cellular phone number.

In some embodiments, the receiving of the SMS-based payment indication may be in accordance with an Application Programming Interface (API).

In some embodiments, the processing device 804 may be further configured for detecting an issue corresponding to the transaction. Also, the processing device 804 may be further configured for performing a remedial action based on the detecting.

In some embodiments, the issue corresponds to the cellular network. Additionally, the communication device 802 may be configured for receiving the SMS message over a non-cellular network based on the performing of the remedial action.

In some embodiments, the processing device 804 may be further configured for encrypting the unique payment request code to generate an encrypted unique payment request code. Accordingly, the unique payment request code may be transmitted to the network connected device 902 associated with the user. Further, the unique payment request code may be the encrypted unique payment request code.

In some embodiments, the processing device 804 may be further configured for verifying an accuracy of the transaction. Accordingly, the processing device 804 may be further configured for reconciling a transaction record associated with the transaction based on the verifying of the accuracy.

In some embodiments, the communication may be further configured for receiving a request for a transaction report from the network connected device 902 associated with the merchant. Further, the communication may be further configured for transmitting a transaction report to the network connected device 902 associated with the merchant. Furthermore, the processing device 804 may be further configured for generating the transaction report based on the request.

In some embodiments, the processing device 804 may be further configured for analyzing the SMS message. Furthermore, the processing device 804 may be further configured for determining the transaction to be fraudulent based on the analyzing of the SMS message. Moreover, the processing device 804 may be further configured for performing a remedial action based upon the determining.

FIG. 9 illustrates a block diagram of the system 800 for facilitating secure payment for a transaction, in accordance with some embodiments.

Although the invention has been explained in relation to its preferred embodiment, it is to be understood that many other possible modifications and variations can be made without departing from the spirit and scope of the invention as hereinafter claimed.

1. A method for facilitating secure payment for a transaction, wherein the method comprises:
receiving, using a communication device, a short message service (SMS)-based payment indication corresponding to a transaction, wherein the SMS-based payment indication is received from a network connected device associated with at least one of a user and a merchant, wherein the transaction is associated with each of the user and the merchant;
receiving, using the communication device, merchant data associated with the transaction, wherein the merchant data comprises at least one account data associated with a merchant financial account;
generating, using a processing device, a unique payment request code associated with the transaction;
transmitting, using the communication device, the unique payment request code to the network connected device;
receiving, using the communication device, a short message service (SMS) message from the network connected device, wherein the SMS message comprises the unique payment request code, wherein the SMS message is received over a cellular network;
verifying, using the processing device, a user identity of the user based on the SMS message;
analyzing, using the processing device, the unique payment request code;
initiating, using the processing device, a transfer of a payment from a user financial account to the merchant financial account based on the verifying of the user identity and the analyzing of the unique payment request code; and
transmitting, using the communication device, an acknowledgment short message service (SMS) message to the network connected device, wherein the transmitting is based on the initiating.

2. The method of claim 1, wherein the unique payment request code is generated based on a user cellular network number and a transaction ID associated with the transaction.

3. The method of claim 1, wherein the SMS message is addressed to a designated cellular phone number.

4. The method of claim 1, wherein the receiving of the SMS-based payment indication is in accordance with an Application Programming Interface (API).

5. The method of claim 1 further comprising:
detecting, using the processing device, an issue corresponding to the transaction; and
performing, using the processing device, a remedial action based on the detecting.

6. The method of claim 5, wherein the issue corresponds to the cellular network, wherein the method comprises receiving, using the communication device, the SMS message over a non-cellular network based on the performing of the remedial action.

7. The method of claim 1 further comprising encrypting, using the processing device, the unique payment request code to generate an encrypted unique payment request code, wherein the unique payment request code is transmitted to the network connected device associated with the user, wherein the unique payment request code is the encrypted unique payment request code.

8. The method of claim 1 further comprising:
verifying, using the processing device, an accuracy of the transaction; and
reconciling, using the processing device, a transaction record associated with the transaction based on the verifying of the accuracy.

9. The method of claim 1 further comprising:
receiving, using the communication device, a request for a transaction report from the network connected device associated with the merchant;
generating, using the processing device, the transaction report based on the request; and
transmitting, using the communication device, the transaction report to the network connected device associated with the merchant.

10. The method of claim 1 further comprising:
analyzing, using the processing device, the SMS message;
determining, using the processing device, the transaction to be fraudulent based on the analyzing of the SMS message; and
performing, using the processing device, a remedial action based upon the determining.

11. A system for facilitating secure payment for a transaction, wherein the system comprises:
a communication device configured for:
receiving a short message service (SMS)-based payment indication corresponding to a transaction, wherein the SMS-based payment indication is received from a network connected device associated with at least one of a user and a merchant, wherein the transaction is associated with each of the user and the merchant;
receiving merchant data associated with the transaction, wherein the merchant data comprises at least one account data associated with a merchant financial account;
transmitting a unique payment request code to the network connected device;
receiving a short message service (SMS) message from the network connected device, wherein the SMS message comprises the unique payment request code, wherein the SMS message is received over a cellular network; and
transmitting an acknowledgment short message service (SMS) message to the network connected device; and
a processing device communicatively coupled with the communication device, wherein the processing device is configured for:
generating the unique payment request code associated with the transaction;
verifying a user identity of the user based on the SMS message;
analyzing the unique payment request code; and
initiating a transfer of a payment from a user financial account to the merchant financial account based on the verifying of the user identity and the analyzing of the unique payment request code, wherein the transmitting of the acknowledgment SMS message to the network connected device is based on the initiating.

12. The system of claim 11, wherein the unique payment request code is generated based on a user cellular network number and a transaction ID associated with the transaction.

13. The system of claim 11, wherein the SMS message is addressed to a designated cellular phone number.

14. The system of claim 11, wherein the receiving of the SMS-based payment indication is in accordance with an Application Programming Interface (API).

15. The system of claim 11, wherein the processing device is further configured for:
detecting an issue corresponding to the transaction; and
performing a remedial action based on the detecting.

16. The system of claim 15, wherein the issue corresponds to the cellular network, wherein the communication device is further configured for receiving the SMS message over a non-cellular network based on the performing of the remedial action.

17. The system of claim 11, wherein the processing device is further configured for encrypting the unique payment request code to generate an encrypted unique payment request code, wherein the unique payment request code is transmitted to the network connected device associated with the user, wherein the unique payment request code is the encrypted unique payment request code.

18. The system of claim 11, wherein the processing device is further configured for:
verifying an accuracy of the transaction; and
reconciling a transaction record associated with the transaction based on the verifying of the accuracy.

19. The system of claim 11, wherein the communication is further configured for:
receiving a request for a transaction report from the network connected device associated with the merchant;
transmitting a transaction report to the network connected device associated with the merchant, wherein the processing device is further configured for generating the transaction report based on the request.

20. The system of claim 11, wherein the processing device is further configured for:
analyzing the SMS message;
determining the transaction to be fraudulent based on the analyzing of the SMS message; and
performing a remedial action based upon the determining.
